(19) United States
(12) Patent Application Publication
(10) Pub. No.: US 2026/0190132 A1
(43) Pub. Date: Jul. 2, 2026

(54) RADIO RESOURCE BLOCK ALLOCATION FOR WIRELESS NETWORKS

(71) Applicant: T-MOBILE INNOVATIONS LLC, Overland Park, KS (US)

(72) Inventors: Krunal Mansukhlal MODASIYA, Aldie, VA (US); Mohd Khalil Bin Abu Bakar, Herndon, VA (US)

(21) Appl. No.: 19/008,441

(22) Filed: Jan. 2, 2025

(51) Int. Cl. H04W 72/53; H04W 72/541

(52) U.S. Cl. CPC H04W 72/53; H04W 72/541

(57) ABSTRACT

Embodiments of the present disclosure are directed to systems and methods for allocating Physical Resource Blocks (PRBs) in cellular telecommunications is disclosed. PRBs, fundamental units of resource allocation in LTE and 5G, are traditionally allocated based on channel quality, data demand, or a round-robin approach. The disclosed method allocates sequential PRBs to multiple PRB pools, each linked to a subsector. A set of user equipment (UEs) located in a particular subsector will be allocated PRBs from that subsector's PRB pool. Subsectors are defined by equal angular widths, UE distribution, or UE demand. This allocation strategy enhances the efficiency and fairness of radio resource distribution by the base station scheduler, thereby decreasing noise and interference levels within the sector.

### SUMMARY

The present disclosure is directed to allocating radio resources in wireless network environments, substantially as shown and/or described in connection with at least one of the Figures, and as set forth more completely in the claims.

The present disclosure describes a system designed to manage radio resources in a wireless network environment, such as Physical Resource Blocks (PRBs) in a cellular network or resource units in a Wi-Fi network. This system includes components that monitor the location of User Equipment (UEs), receive resource requests, and gather connection quality reports. The information collected is used to divide the sector into smaller subsectors based on various criteria such as angular width, UE distribution, or resource demand. PRBs are then allocated to these subsectors, and UEs in a particular subsector are allocated PRBs from that subsector's PRB pool. The allocation to individual UEs within a subsector can be done using different methods like prioritizing the best channel conditions, ensuring equal access, or balancing demand and fairness. The system communicates the PRB allocations to the UEs, enhancing the efficiency and fairness of resource distribution while reducing noise and interference levels within the sector.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates a network environment in which implementations of the present disclosure may be employed;

FIGS. 3A-3B. illustrate environments in which implementations of the present disclosure may be employed; and

FIG. 4 depicts a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “mmWave” means RF waves having a wavelength measured in millimeters or fractions of millimeters (i.e., less than one cm), generally in the range of 30 GHz-3 THz, though frequencies above and below that range may still be used by aspects of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, A Physical Resource Block (PRB) is the fundamental unit of resource allocation in cellular telecommunications, defined in both the frequency and time domains. In LTE and 5G, a PRB represents a block of 12 consecutive subcarriers over a specific frequency bandwidth (e.g., 180 kHz for 15 kHz subcarrier spacing) and a defined time interval (e.g., one slot, typically 0.5 ms in 5G). PRBs serve as the building blocks for transmitting data, control information, and signaling between the base station and UEs. Within the cellular paradigm, the base station dynamically allocates PRBs to UEs to efficiently share available spectrum and meet the diverse demands of connected devices. This allocation is conventionally managed by a scheduler, which determines the distribution of PRBs based on factors such as channel quality, data demand, and fairness criteria. The PRB assignments are communicated to UEs via Downlink Control Information (DCI) on the Physical Downlink Control Channel (PDCCH), enabling each UE to decode its assigned PRBs for uplink or downlink communications.

Unlike conventional solutions, which allocate PRBs based on channel quality, data demand, or in a round robin approach, the present disclosure is directed to equally allocating sequential PRBs to each of a plurality of PRB pools. Each PRB pool is associated with a subsector. A sector is partitioned into subsectors based on equal angular widths, distribution of UEs in the sector, or UE demand for radio resources within the sector. The UEs in a particular subsector will be allocated PRBs from the PRB pool associated with that particular subsector. By allocating sequential PRBs to a particular pool, a base station scheduler may more efficiently and fairly allocate radio resources, and overall noise/interference levels in the sector may be decreased.

Accordingly, a first aspect of the present disclosure is directed to a system for allocating radio resources in a wireless network environment. The system comprises a base station configured to wirelessly communicate with each of a plurality of user equipment (UEs) located in a sector, the plurality of UEs comprising a first UE and second UE. The system further comprises one or more computer processing components configured to partition the sector into a plurality of subsectors, the plurality of subsectors comprising a first subsector and a second subsector. The one or more computer processing components are further configured to allocate an equal number of sequential physical resource blocks (PRBs) to each subsector of the plurality of subsectors. The one or more computer processing components are further configured to allocate at least one PRB from a first set of PRBs to the first UE, the first set of PRBs being allocated to the first subsector, based on a determination that the first UE is located in the first subsector. The one or more computer processing components are further configured to allocate at least one PRB from a second set of PRBs to the second UE, based on a determination that the second UE is located in the second subsector, the second set of PRBs being allocated to the second subsector, and the first set of PRBs being different than the second set of PRBs.

A second aspect of the present disclosure is directed to a method for allocating radio resources in a wireless network environment. The method comprises partitioning a sector served by a base station into a plurality of subsectors, the plurality of subsectors comprising a first subsector and a second subsector. The method further comprises allocating an equal number of sequential radio resource units to each subsector of the plurality of subsectors. The method further comprises, based on a determination that a first user equipment (UE) is located in the first subsector, allocating at least one radio resource unit from a first set of radio resource units to the first UE, the first set of radio resource units being allocated to the first subsector. The method further comprises, based on a determination that a second UE is located in the second subsector, allocating at least one radio resource unit from a second set of radio resource units to the second UE, the second set of radio resource units being allocated to the second subsector, the first set of radio resource units being different than the second set of radio resource units.

Another aspect of the present disclosure is directed to a non-transitory computer readable media having instructions stored thereon that, when executed by one or more computer processing components, cause the one or more computer processing components to perform a method for allocating radio resources in a wireless network environment. The method comprises partitioning a sector served by a base station into a plurality of subsectors, the plurality of subsectors comprising a first subsector and a second subsector. The method further comprises allocating an equal number of sequential radio resource units to each subsector of the plurality of subsectors. The method further comprises, based on a determination that a first user equipment (UE) is located in the first subsector, allocating at least one radio resource unit from a first set of radio resource units to the first UE, the first set of radio resource units being allocated to the first subsector. The method further comprises, based on a determination that a second UE is located in the second subsector, allocating at least one radio resource unit from a second set of radio resource units to the second UE, the second set of radio resource units being allocated to the second subsector, the first set of radio resource units being different than the second set of radio resource units.

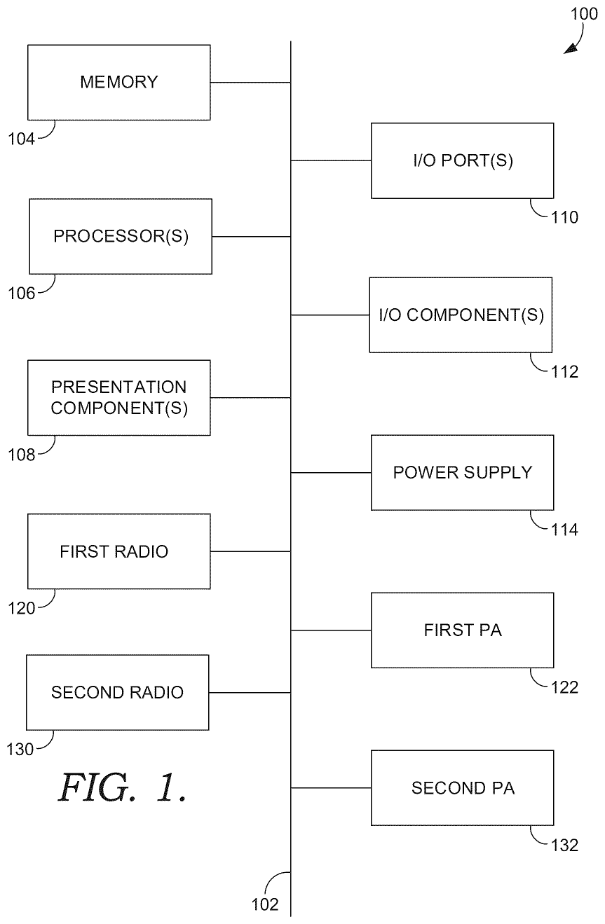

Referring to FIG. 1, a representative computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) devices (e.g., virtual reality, augmented reality, or mixed reality devices), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of one example of a computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. The memory 104 may take the form of solid-state memory, hard drives, optical-disc drives, etc. Computing device 100 includes one or more processors 106 that read data from various entities such as bus 102, memory 104 or I/O components 112. One or more presentation components 108 presents data indications to a person or other device. The one or more presentation components 108 may comprise one or more of a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may be configured to communicate with one or more other computing devices according to a local area communication protocol (e.g., IEEE 802.11 series, Bluetooth, NFC, z-wave, or the like).

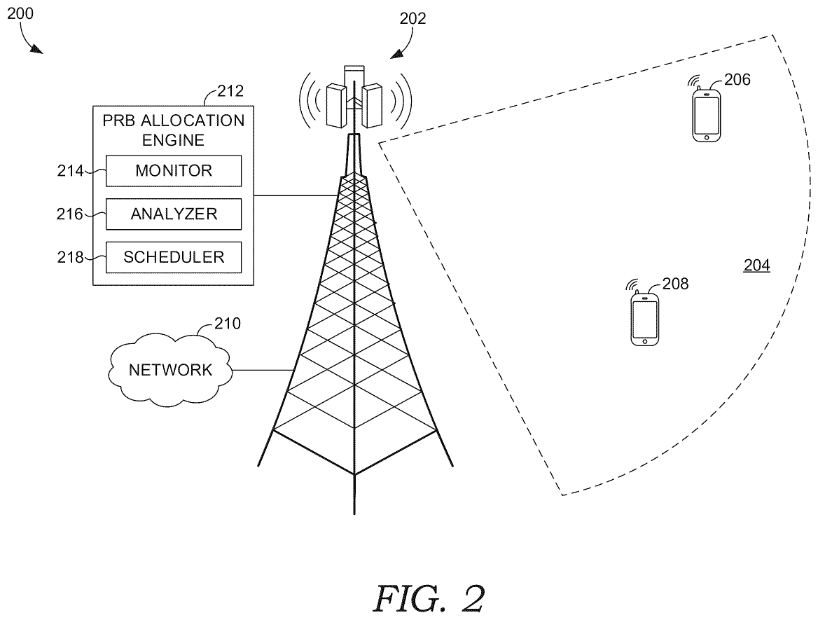

Turning now to FIG. 2, a representative network environment is illustrated in which implementations of the present disclosure may be employed. Such a network environment is illustrated and designated generally as network environment 200. At a high level the network environment 200 comprises one or more UEs, one or more base stations, and one or more networks. Though each of a first UE 206 and a second UE 208 are illustrated as cellular phones, a UE suitable for implementations with the present disclosure may be any computing device having any one or more aspects described with respect to FIG. 1. Similarly, though a base station 202 is illustrated as a macro cell on a cell tower, any scale or form of access point acting as a transceiver station for wirelessly communicating with a UE, including small cells, pico cells, smart home hubs that manage devices using short-range connections (e.g., Bluetooth), Wi-Fi routers, and the like, are suitable for use with the present disclosure.

The network environment 200 comprises one or more base stations with which a UE may wirelessly communicate. The base station 202 comprises hardware and software components that allow it to wirelessly communicate with one or more UEs in one or more coverage areas. Each coverage area may be logically defined in space and frequency as one or more cells and/or sectors, which may or may not overlap. An example of such a coverage area is sector 204, in which the base station 202 is configured to wirelessly communicate with each of the first UE 206 using a first wireless connection and the second UE 206 using a second wireless connection. Using any radio access technology selected by a mobile network operator (e.g., 4G, 5G, 6G, Wi-Fi (e.g., Wi-Fi 6/6E), Bluetooth, Zigbee, Z-Wave, LoRaWAN, NB-IoT (Narrowband IoT), and LTE-M, and the like), the base station 202 may transmit and receive wireless signals using one or more antenna elements.

Each base station of the one or more base stations may be associated with one or more at least partially distinct networks 210, wherein each network is associated with one or more network identifiers. The network 210 may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations.

In a cellular deployment, the base station 202 is configured to communicate with the first UE 206 and the second UE 208 using physical resource blocks. A Physical Resource Block (PRB) is the smallest unit of resource allocation in a cellular network, defined in both the frequency and time domains. In 5G and LTE, a PRB comprises a fixed number of subcarriers (e.g., 12 subcarriers) over a specific bandwidth (e.g., 180 kHz) and for a defined time interval (e.g., one slot in 5G). The number of PRBs available in a time slot depends on the channel bandwidth and the subcarrier spacing (SCS) used. For example, in a 15 MHz channel with an SCS of 15 kHz, the total available bandwidth is divided into 79 PRBs, each occupying 180 kHz of spectrum. However, if the SCS increases to 30 kHz, the bandwidth per PRB remains the same, but fewer PRBs (e.g., 39 PRBs for the same 15 MHz channel) are available in a time slot due to increased spacing between subcarriers. The base station 202 dynamically schedules and controls the allocation of PRBs within its sector. These assignments are communicated to the UE via Downlink Control Information (DCI) within the Physical Downlink Control Channel (PDCCH), enabling a UE to decode its allocated PRBs. The dynamic allocation process ensures that the UE receives sufficient resources for uplink and downlink communications while minimizing interference and optimizing overall network performance. Although the discussion herein focuses on cellular deployments using PRBs, similar principles are contemplated for Wi-Fi deployments, where resource allocation may be performed using Resource Units (RUs) in protocols such as Wi-Fi 6/6E and Wi-Fi 7.

In order to make schedule and control the allocation of PRBs within the sector 204, the base station 202 comprises one or more computer processing components that, together, may be said to comprise a PRB allocation engine 212. Though illustrated as a dedicated engine comprising three discrete modules, one skilled in the art will appreciate that different deployments of hardware and software may be utilized to carry out the inventive concept of the present disclosure without departing therefrom. The PRB allocation engine 212 may be deployed at the base station 202, a network edge (not illustrated), or within the network 210. The PRB allocation engine 212 may be said to comprise a monitor 214, an analyzer 216, and a controller 218.

The monitor 214 is generally configured to determine a UE's location within the sector 204, receive radio resource requests from the UEs, and receive measurement reports from the UEs. The monitor 214 is also configured to communicate said information to the analyzer 216.

The monitor 214 is configured to determine the location of a UE within the sector 204 using one or more methods. In one method, the UE provides its geo-coordinates directly to the base station as part of a location information message, which may include data derived from GPS or other location services. While the base station 202 may not process this information directly, the location data can be passed to the network 210, where a location management function or other network component processes and communicates the UE's location back to the base station 202 for use in resource allocation or other functions. In other aspects, the monitor 214 can determine the UE's location within the sector by analyzing the angle of arrival (AoA) of signals transmitted by the UE. Determining the AoA involves estimating the direction of the incoming signal relative to the base station 202's antenna array, allowing the base station 202 to infer the UE's location within the sector 204. While AoA does not provide absolute geographic coordinates, it establishes a precise line of bearing or directional vector, which can be used to locate the UE relative to the base station. To determine AoA, the base station uses phase information of uplink signaling transmitted by the UE. These uplink signals enable the base station to calculate the phase differences of received signals across its antenna array elements, facilitating accurate AoA measurements. Uplink signaling usable for AoA estimation may include one or more of the PUSCH (Physical Uplink Shared Channel) for user data transmissions, the SRS (Sounding Reference Signal) for precise spatial and frequency domain measurements, and the PRACH (Physical Random Access Channel) during random access or handover procedures. Additionally, the DMRS (Demodulation Reference Signal), transmitted alongside PUSCH or PUCCH (Physical Uplink Control Channel).

The monitor 214 may be further configured to receive radio resource requests from UEs within the sector 204, with such requests providing detailed information about the UEs'resource requirements. These requests may include metrics such as the UE's current data demands, quality of service (QoS) requirements, or uplink and downlink throughput needs, conveyed through standardized signaling mechanisms. For instance, UEs may transmit Buffer Status Reports (BSRs), which detail the size of the data waiting in the UE's uplink buffer, allowing the base station to assess uplink demand. Similarly, QoS Class Identifiers (QCIs), included in signaling messages, indicate the priority, latency, and reliability requirements for specific traffic flows. These resource requests are typically sent as part of periodic or event-driven uplink signaling, such as on the Physical Uplink Control Channel (PUCCH) or embedded within the Physical Uplink Shared Channel (PUSCH) during active data transmissions. The frequency of these messages can vary based on the network configuration and UE activity, ranging from periodic updates (e.g., every few milliseconds during high activity) to on-demand reporting triggered by changes in data demand or network conditions. Additionally, in scenarios requiring initial access or connection re-establishment, the Physical Random Access Channel (PRACH) may be used to initiate communication and convey basic resource requirements.

The monitor 214 may be further configured to receive measure reports from UEs within the sector 204 that characterize the wireless connection between the reporting UE and the base station 202, which may be taken into consideration for radio resource allocations. These reports may include one or more key performance indicators (KPIs) such as the Reference Signal Received Power (RSRP), Reference Signal Received Quality (RSRQ), and Signal-to-Interference-plus-Noise Ratio (SINR), and the like, each of which reflect different aspects of the UE's connection with the base station 202. The measurement reports are transmitted by UEs in accordance with standardized reporting configurations, such as those defined in LTE or 5G NR specifications, and may be sent periodically, event-triggered (e.g., when a metric crosses a predefined threshold), or on demand based on an instruction from the base station 202. Measurement reports are typically transmitted on the Physical Uplink Control Channel (PUCCH), although they may also be embedded within uplink data packets on the Physical Uplink Shared Channel (PUSCH) when the UE is actively transmitting data. The frequency and content of these reports are configurable by the network and can be adapted to specific scenarios, such as dense urban deployments where frequent reporting is necessary for interference management, or low-mobility environments where less frequent updates suffice.

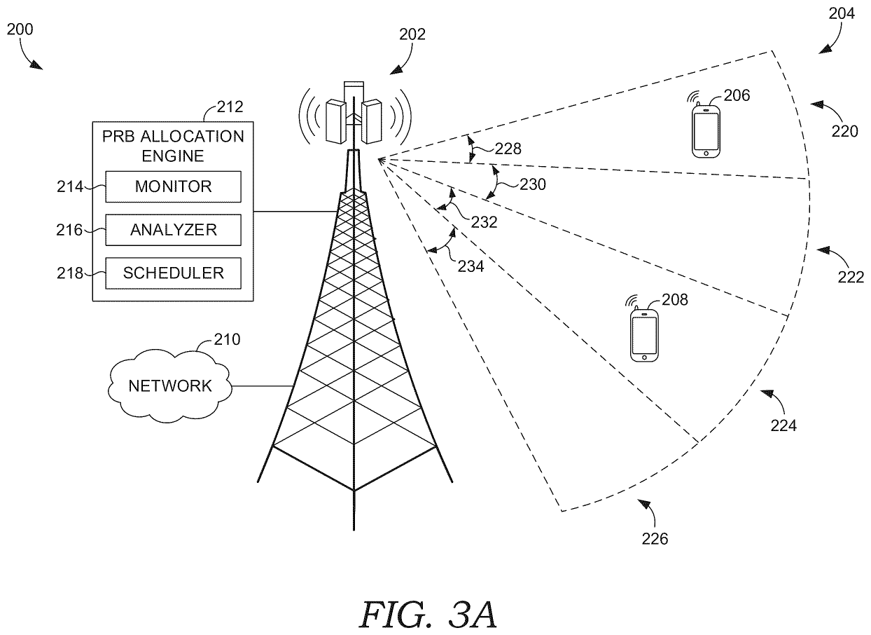

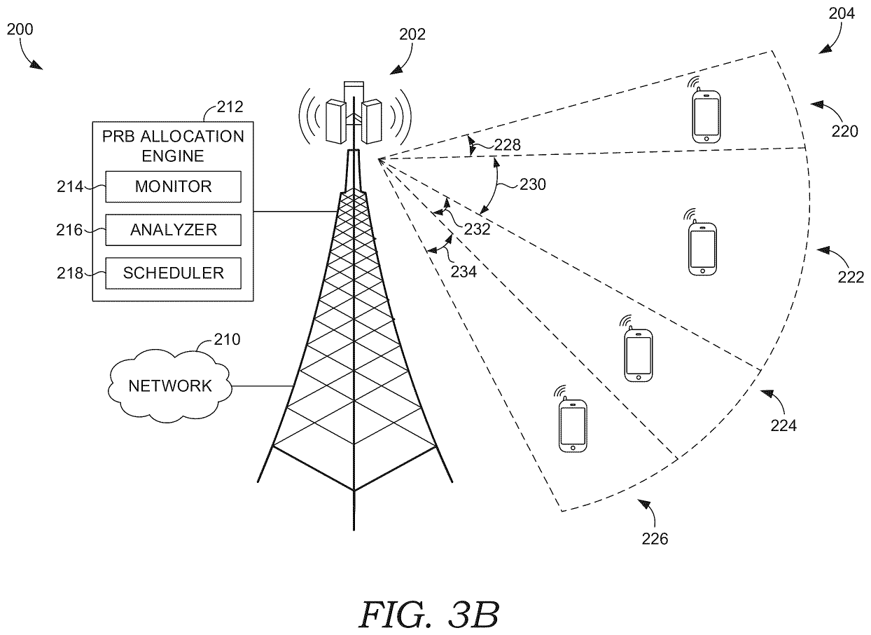

The analyzer 216 is generally configured to partition the sector 204 into a plurality of subsectors that are used by the PRB allocation engine 212 to make PRB allocation decisions. Turning now to FIG. 3A, the network environment 200 of FIG. 2 is illustrated, wherein the analyzer 216 of the PRB allocation engine 212 partitions the sector 204 into a plurality of angularly equal subsectors. In one example, if the sector 204 has a horizontally angular width of 90 degrees, then in the aspect illustrated by FIG. 3A, the analyzer 216 will partition the sector 204 into a plurality of subsectors with equal horizontal angular widths. Continuing with the example, if the analyzer 216 was configured to partition the sector 204 into four subsectors, then each of a first angular width 228 of a first subsector 220, a second angular width 230 of a second subsector 222, a third angular width 232 of a third subsector 224, and a fourth angular width 234 of a forth subsector would be equal. Though illustrated as a partition into four subsectors, the analyzer 216 may be configured to partition the sector 204 into any number of subsectors desirable by a mobile network or RAN operator (e.g., 3, 6, 9, etc.).

Turning now to FIG. 3B, the network environment 200 of FIG. 2 is illustrated, wherein the analyzer 216 of the PRB allocation engine 212 partitions the sector 204 into a plurality of subsectors with an equal number of UEs or an equal amount of UE resource requirements. In one example, if the sector 204 comprises 40 UEs, then the analyzer 216 may partition the sector 204 into four subsectors wherein each subsector has 10 UEs, represented in FIG. 3B by a single UE in each subsector. Accordingly, the first angular width 228 will be defined by that which captures 10 UEs in the first subsector 220, the second angular width 230 will be defined by that which captures the next 10 UEs in the second subsector 222, and so on. Continuing with the previous example, if the ten UEs closest to one edge of the sector 204 are locate within 10 degrees of said sector edge, then the first subsector 220 will have the first angular width 228 equal to 10 degrees; if the next 10 UEs are disposed in a 30 degree range of a boundary between the first subsector 220 and the second subsector 222, then the second angular width will be equal to 30 degrees. In aspects wherein the analyzer 216 parititions the subsectors based on equal number of UE resource requirements, it is contemplated that both the angular widths and the number of UEs in each subsector will be unequal; that is, a boundary between the first subsector 220 and the second subsector 222 may be established based on a first set of UEs in the first subsector 220 having an equal (or approximately equal) amount of radio resources requested from the base station 202 as an amount of radio resources requested by a second set of UEs in the second subsector 222—even if the number of UEs in the first set is not equal to the number of UEs in the second set. In the aspect illustrated by FIG. 3B, it is contemplated (if not likely) that each of the angular widths of the plurality of subsectors will be different. Further, the scheme illustrated by FIG. 3B is dynamic; as the numbers of UEs enter, exit, or move about the sector 204, the analyzer will modify the angular widths of one or more of the plurality of subsectors in order to preserve the equal UE or equal demand configuration.

With reference to FIGS. 3A-3B, once the analyzer 216 partitions the sector 204 into a plurality of subsectors, the analyzer is configured to make PRB allocations to the UEs within each subsector. In order to make the PRB allocations, the analyzer 216 may first determine a maximum quantity of PRBs available in a time slot using a particular radio configuration that is used by the base station 202; for example, if the base station 202 is configured to use a 15 kHz subcarrier spacing with a 10 MHz channel bandwidth, then the analyzer will determine that the maximum quantity of available PRBs in time slot is 52. Once the analyzer 216 determines the maximum number of available PRBs in a time slot, the analyzer 216 is configured to equally apportion the maximum number of PRBs into a plurality of PRB pools that are equal to the number of subsectors partitioned by the analyzer 216; for example, if the analyzer 216 partitions the sector 204 into four subsectors and 52 PRBs are available for the full sector 204, then the analyzer 216 will allocate 13 PRBs to each of four PRB pools, wherein each pool is used to make PRB allocations to one subsector. Using UE location information from the monitor 214, the analyzer 216 is configured to associate a UE with a particular pool of PRBs in order to make a PRB allocation decision. Returning to FIG. 2, and continuing with the previous example, the analyzer 216 may allocate PRBs 1-13 to a first pool for allocation to UEs within the first subsector 220, PRBs 14-26 to a second pool for allocation to UEs within the second subsector 222, PRBs 27-39 to a third pool for allocation to UEs within the third subsector 224, and PRBs 40-52 to a fourth pool for allocation to UEs within the fourth subsector 226. Accordingly, the base station 202 would allocate PRBs from the first pool to the first UE 206 based on the first UE 206 being located in the first subsector and would allocate PRBs from the third pool to the second UE 208 based on the second UE being located in the third subsector 224.

Once a pool of PRBs is allocated to a subsector by the analyzer 216, the analyzer may allocate PRBs to individual UEs according to various sub-schemes, such as max Carrier over Interference (Max C/I), Round Robin, Proportional Demand, and Proportional Fair. Using the Max C/I scheme, the analyzer 216 allocates PRBs to UEs with the highest Signal-to-Interference-plus-Noise Ratio (SINR) or Channel Quality Indicator (CQI) for each PRB, prioritizing UEs with the best channel conditions to maximize spectral efficiency. Using the Round Robin scheme, the analyzer 216 allocates PRBs sequentially and cyclically to UEs, ensuring equal opportunity to access resources without considering channel conditions. For example, if 4 UEs are in a first subsector and 13 PRBs are available to the PRB pool allocated to the first subsector, Round Robin would assign PRBs in a looped order such that a first UE might receive PRBs 1, 5, 9, and 13; a second UE might receive PRBs 2, 6, and 10, and so on. For the Proportional Demand scheme, the analyzer 216 allocates PRBs based on each UE's current data demand, distributing more PRBs to UEs with higher data requirements while still maintaining fairness across the sector. Using the Proportional Fair scheme, the analyzer 216 balances efficiency and fairness by allocating PRBs based on the ratio of a UE's instantaneous throughput potential (e.g., based on CQI) to its historical average throughput, prioritizing UEs with favorable channel conditions while ensuring equitable resource distribution over time.

If a pool of PRBs is allocated to a subsector in excess of the needs of that subsector, then the analyzer 216 may re-allocate one pool of PRBs to another; for example, if the analyzer 216 partitioned the sector 204 according to the scheme illustrated in FIG. 3A there may be a circumstance where the first subsector 220 has a fewer number of UEs than the second subsector 222. If the number of UEs in the first subsector do not require the full amount of PRBs allocated to the first pool, then the analyzer 216 may re-allocate the unallocated PRBs to UEs in the second subsector 222 (or any other subsector wherein demand exceeds the supply of PRBs in that subsector's PRB pool.

Though illustrated and described as a horizontal partitioning in FIGS. 3A-3B, it is contemplated that the partitioning and PRB allocation scheme described herein may be implemented in a vertical embodiment, a two-dimensional embodiment, or a three-dimensional embodiment, wherein each of the spatially equal schemes are with reference to a point where signals are emitted from the base station 202. In a vertical aspect, a sector may be partitioned into vertical subsectors; for example, if the sector 204 has a vertically angular width of 15 degrees and a horizontal angular width of 90 degrees, then the analyzer 216 may partition the sector 204 into three subsectors, wherein each subsector has a vertically angular width of 5 degrees and a horizontal angular width of 90 degrees. In other aspects, the analyzer 216 may partition the sector 204 using a two dimensional scheme, wherein each subsector is defined by a particular horizontal and vertical angular width that is less than the total vertical and horizontal angular widths of the sector 204. In yet other aspects, the analyzer 216 may partition the sector 204 using a three dimensional scheme, wherein each subsector is defined by a particular horizontal angular width, a vertical angular width, and a distance from the base station 202.

The scheduler 218 is generally configured to communicate PRB allocations to the one or more UEs served by the base station 202 in the sector 204. The scheduler 218 allocates PRBs to UEs within the sector 204 and communicates these allocations to the respective UEs using the Downlink Control Information (DCI) transmitted via the Physical Downlink Control Channel (PDCCH). The DCI specifies the PRBs assigned to each UE, the modulation and coding scheme (MCS) to be used, and other necessary transmission parameters. Once the allocation is communicated, the assigned PRBs are used by the base station 202 to transmit downlink symbols containing the data requested by the UE, fulfilling its data demands for the given scheduling period, including user data, acknowledgments, or other control information.

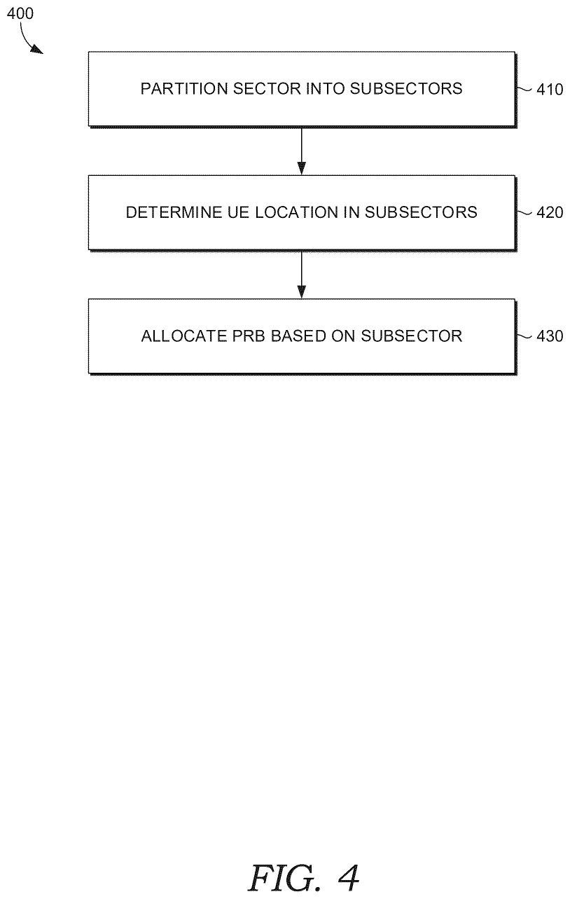

Turning now to FIG. 4, a flow chart representing a method 400 is provided for allocating PRBs to UEs in a sector. At a first step 410, a sector, such as the sector 204 of FIGS. 2-3B is partitioned into a plurality of subsectors, according to any one or more aspects descried with respect to FIGS. 2-3B. At a second step 420, a location is determined for each of a plurality of UEs located in the sector and a PRB pool is determined based on dividing a maximum number of PRBs by the number of partitioned subsectors, according to any one or more aspects descried herein with respect to FIGS. 2-3B. At a third step 430, PRBs are allocated to UEs, wherein each UE is allocated one or more PRBs from a pool of PRBs associated with the subsector in which the UE is located, according to any one or more aspects described with respect to FIGS. 2-3B.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for allocating radio resources in a wireless network environment, the system comprising:
a base station configured to wirelessly communicate with each of a plurality of user equipment (UEs) located in a sector, the plurality of UEs comprising a first UE and second UE; and
one or more computer processing components configured to perform operations comprising:
partitioning the sector into a plurality of subsectors, the plurality of subsectors comprising a first subsector and a second subsector;
allocating an equal number of sequential physical resource blocks (PRBs) to each subsector of the plurality of subsectors;
based on a determination that the first UE is located in the first subsector, allocating at least one PRB from a first set of PRBs to the first UE, the first set of PRBs being allocated to the first subsector; and
based on a determination that the second UE is located in the second subsector, allocating at least one PRB from a second set of PRBs to the second UE, the second set of PRBs being allocated to the second subsector, the first set of PRBs being different than the second set of PRBs.

2. The system of claim 1, wherein partitioning the sector into a plurality of subsectors comprises dividing the sector into spatially equal subsectors.

3. The system of claim 2, wherein the operations further comprise determining that a subset of the first set of PRBs is unused for serving one or more UEs located in the first subsector and re-allocating the subset of the first set of PRBs to the second subsector.

4. The system of claim 3, wherein the partitioning is based on each subsector having an equal horizontal angular width.

5. The system of claim 4, wherein determining that the first UE is located in the first subsector and that the second UE is located in the second subsector is based on an angle of arrival of uplink signals received from each of the first UE and the second UE.

6. The system of claim 4, wherein determining that the first UE is located in the first subsector and that the second UE is located in the second subsector is based on a location report from each of the first UE and the second UE.

7. The system of claim 3, wherein the partitioning is based on each subsector having an equal vertical angular width.

8. The system of claim 3, wherein the partitioning is based on each subsector having an equal two-dimensional profile, the two-dimensional profile comprising a horizontal angular width and a vertical angular width.

9. The system of claim 3, wherein the partitioning is based on each subsector having an equal three-dimensional profile, the three-dimensional profile comprising a horizontal angular width, a vertical angular width, and a range of distances from the base station.

10. The system of claim 1, wherein the operations further comprise determining that a first set of the plurality of UEs are located in the first subsector, the first set of the plurality of UEs comprising the first UE, and wherein the first set of PRBs are allocated to the first set of the plurality of UEs using a maximum carrier over interference scheme.

11. The system of claim 1, wherein the operations further comprise determining that a first set of the plurality of UEs are located in the first subsector, the first set of the plurality of UEs comprising the first UE, and wherein the first set of PRBs are allocated to the first set of the plurality of UEs using a round robin scheme.

12. The system of claim 1, wherein the operations further comprise determining that a first set of the plurality of UEs are located in the first subsector, the first set of the plurality of UEs comprising the first UE, and wherein the first set of PRBs are allocated to the first set of the plurality of UEs using proportional demand scheme.

13. The system of claim 1, wherein the operations further comprise determining that a first set of the plurality of UEs are located in the first subsector, the first set of the plurality of UEs comprising the first UE, and wherein the first set of PRBs are allocated to the first set of the plurality of UEs using a proportional fair scheme.

14. The system of claim 1, wherein partitioning the sector into a plurality of subsectors comprises dividing the sector into subsectors having an equal number of UEs.

15. The system of claim 1, wherein partitioning the sector into a plurality of subsectors comprises dividing the sector into subsectors having an equal radio resource demand.

16. A method for allocating radio resources in a wireless network environment, the method comprising:
partitioning a sector served by a base station into a plurality of subsectors, the plurality of subsectors comprising a first subsector and a second subsector;
allocating an equal number of sequential radio resource units to each subsector of the plurality of subsectors;
based on a determination that a first user equipment (UE) is located in the first subsector, allocating at least one radio resource unit from a first set of radio resource units to the first UE, the first set of radio resource units being allocated to the first subsector; and
based on a determination that a second UE is located in the second subsector, allocating at least one radio resource unit from a second set of radio resource units to the second UE, the second set of radio resource units being allocated to the second subsector, the first set of radio resource units being different than the second set of radio resource units.

17. The method of claim 16, wherein determining that the first UE is located in the first subsector and that the second UE is located in the second subsector is based on an angle of arrival of uplink signals received from each of the first UE and the second UE.

18. The method of claim 17, wherein the base station is a cellular base station and the radio resource unit comprises a physical resource block.

19. The method of claim 17, wherein the base station is a Wi-Fi router and the radio resource unit comprises a resource unit.

20. A non-transitory computer readable media having instructions stored thereon that, when executed by one or more computer processing components, cause the one or more computer processing components to perform a method for allocating radio resources in a wireless network environment, the method comprising:
partitioning a sector served by a base station into a plurality of subsectors, the plurality of subsectors comprising a first subsector and a second subsector;
allocating an equal number of sequential radio resource units to each subsector of the plurality of subsectors;
based on a determination that a first user equipment (UE) is located in the first subsector, allocating at least one radio resource unit from a first set of radio resource units to the first UE, the first set of radio resource units being allocated to the first subsector; and
based on a determination that a second UE is located in the second subsector, allocating at least one radio resource unit from a second set of radio resource units to the second UE, the second set of radio resource units being allocated to the second subsector, the first set of radio resource units being different than the second set of radio resource units.
